(19) United States
(12) Patent Application Publication
(10) Pub. No.: US 2024/0125104 A1
(43) Pub. Date: Apr. 18, 2024

(54) SANITARY SYSTEM

(71) Applicant: GEBERIT INTERNATIONAL AG, Jona (CH)

(72) Inventor: Daniel RAISSLE, Altendorf (CH)

(73) Assignee: GEBERIT INTERNATIONAL AG, Jona (CH)

(21) Appl. No.: 18/482,652

(22) Filed: Oct. 6, 2023

(30) Foreign Application Priority Data
Oct. 12, 2022 (EP) 22 201 081.1

(51) Int. Cl. E03D 5/10; H04L 12/66

(52) U.S. Cl. CPC E03D 5/105; H04L 12/66

(57) ABSTRACT

A sanitary system having at least one sanitary article respectively having a sanitary article controller and an actuator, wherein the sanitary article controller is configured to drive the actuator according to the intended use and wherein the sanitary article controller has a sanitary article communication interface, at least one gateway having a gateway communication interface and a memory which is connected to the gateway communication interface, and a processor. The at least one gateway is connected via the gateway communication interface to the sanitary communication interface via a data connection. The memory is configured to store received operational data, and the processor is configured to evaluate received operational data. When a predetermined evaluation criterion is reached from the evaluation of received operational data, the processor provides an isolated control instruction.

### TECHNICAL FIELD

The present invention relates to a sanitary system according to claim 1.

### PRIOR ART

Networked sanitary systems are known from the prior art. For example, DE 93 13 983 U1 discloses driving of various sanitary elements with a central controller. WO 2009/061857 reveals the linking of a sanitary infrastructure to the Internet.

### SUMMARY OF THE INVENTION

It is an object of the present invention to provide a networked sanitary system which has extended functionalities.

This object is achieved by the sanitary system according to claim 1. According thereto, a sanitary system comprises
at least one sanitary article respectively having a sanitary article controller and an actuator, wherein the sanitary article controller is configured to drive the actuator according to its intended use or to specification, respectively, and wherein the sanitary article controller has a sanitary article communication interface,
at least one gateway having a gateway communication interface, and
a memory which is connected to the gateway communication interface, and a processor. The at least one gateway is connected via the gateway communication interface to the sanitary article communication interface via a data connection.

The data connection is configured in such a way that operational data of the sanitary article controller and/or of the actuator are transmittable to the gateway via the data connection. The memory is configured in such a way as to store the received operational data. The processor is configured in such a way as to evaluate the received operational data. When a predetermined evaluation criterion is reached from the evaluation of the received operational data, the processor provides an isolated control instruction.

The expression “operational data” is understood to mean data which relate to the state and/or the functionality of the actuator or of the sanitary article controller. For example, these are the number of actuations or the number of actuations per unit time or a volume of water per actuation. The evaluation criterion is, for example, the reaching of a specific number of actuations or the reaching of a specific volume of water or the absence of an actuation over a specific time.

The isolated control instruction may, as described below, be transmitted to the sanitary article and/or to a third system. An “isolated control instruction” is understood to mean a control instruction which does not modify the intended functionality of the sanitary article controller and of the actuator per se. This means that the driving according to the intended use is not modified by the isolated control instruction. By the targeted driving of the sanitary article with the isolated control instruction by the gateway, the sanitary article may be driven independently of the driving according to the intended use. In particular, the sanitary article or articles may thereby be connected into a superordinate system and may be driven for a further function which is different from the driving according to the intended use.

Preferably, the memory and the processor are integrated in the gateway. In other embodiments, the memory and the processor are integrated in a building management system or a computer, the building management system or the computer being operatively connected to the gateway.

Another advantage is that all the operational data may be stored centrally in the memory, for example on the gateway. In this way, the operational data may be evaluated at a central location and the isolated control instructions may then be sent in targeted fashion to the sanitary articles on the basis of the data evaluation. The evaluation at a central location has the advantage that the operational data of all the sanitary article controllers converge at a central location during operative use. This has the advantage that the gateway can drive individual sanitary articles in targeted fashion with the isolated control instruction on the basis of all the operational data. Networking of the individual sanitary article controllers with one another may accordingly be obviated.

The possibility is furthermore offered that the parameters required for the operative use, for example pipeline lengths or pipe dimensions, are stored in a digital format in the gateway and then can be consulted for the evaluation criterion and/or for the isolated control instruction. The parameters may, for example, be made available in digital form to the gateway from the building planning in automated fashion.

The expression “driving according to the intended use” or “driving according to the specification” is to be understood as meaning that the sanitary article controller drives the actuator so that a function which corresponds to the normal use of the sanitary article can be triggered on the sanitary article. The sanitary article may be configured in a variety of ways, the sanitary article controller driving the actuator for the use of the sanitary article according to the intended use.

In one variant, the sanitary article is a urinal with a flush device and the sanitary article controller is a urinal controller, the actuator being a flush valve in the flush device, which is driven by the urinal controller, as a result of which flush water is supplied to the urinal. In this way, the substances lying in the urinal are flushed away. The flush device is for example a cistern.

In another variant, the sanitary article is a toilet bowl with a flush device and the sanitary article controller is a toilet controller, the actuator being a flush valve in the flush device, which is driven by the toilet controller, as a result of which flush water is supplied to the toilet body. In this way, the substances lying in the toilet body are flushed away. The flush device is for example a cistern.

If the sanitary article is a urinal or a toilet bowl, the driving of the actuator according to the intended use is for example flushing at specific time intervals or flushing after the detection of a user. The isolated control instruction may be an extreme flush when the sanitary article has not been used for a prolonged period of time. For example, in order to prevent drying of an odour trap or to provide a hygienic flush. During the hygienic flush, the sanitary article lying at the end of a supply line is typically driven.

In summary, the driving according to the intended use for the urinal or the toilet bowl is a flush trigger after use has been detected, wherein to this end a flush valve is correspondingly opened. The driving according to the intended use in this case ensures disposal of the substances lying in the urinal or the toilet, such as excretions, toilet paper, etc.

In another variant, the sanitary article is an outlet fixture and the sanitary article controller is an outlet fixture controller, the actuator being a valve on the outlet fixture, which is driven by the outlet fixture controller, as a result of which the outlet fixture provides water. The outlet fixture may be a tap on a wash basin or a shower element in a shower, such as a shower head or a shower sprinkler. Here, the driving according to the intended use is opening and closing of the valve, for example when a user is detected or in the event of a user input or in the event of a user response.

Preferably, the isolated control instruction is transmittable from the gateway to the sanitary article controller via the data connection, the sanitary article controller driving the actuator with the isolated control instruction.

Preferably, the isolated control instruction drives the actuator independently of the driving according to the intended use. The actuator is a valve and the isolated control instruction is a hygienic flush instruction, with which the valve is opened for a predetermined period of time and is closed again after the predetermined period of time has elapsed.

The isolated control instruction opens the valve independently of the driving according to the intended use and can thus provide the hygienic flush. In the application case of hygienic flushing, the predetermined evaluation criterion would be the detection of a period of time after a last flush, the evaluation criterion being reached when the period of time has exceeded a predetermined period of time and the isolated control instruction then being provided.

When there are a plurality of sanitary articles, the gateway drives that or those sanitary articles which are intended for a hygienic flush on the basis of the pipe topology and/or hygiene logic stored in the gateway. Typically, the sanitary article lying at the end of a fresh water line is driven for the purpose of the hygienic flush.

Preferably, the sanitary article is a hygienic flush apparatus and the actuator is a valve, the driving according to the intended use being deactivated when the data connection has been provided, and the isolated control instruction being a hygienic flush instruction, with which the valve is opened for a predetermined period of time and is closed again after the predetermined period of time has elapsed.

The predetermined evaluation criterion would in this variant be the detection of a period of time after a last flush, the evaluation criterion being reached when the period of time has exceeded a predetermined period of time and the isolated control instruction then being provided.

Preferably, the driving according to the intended use is assigned to the gateway and the isolated control instruction is a control instruction according to the intended use, such that the actuator is driven centrally by the gateway.

This embodiment is particularly advantageous when the sanitary system has a multiplicity of sanitary articles. For example, a toilet and urinal installation in a semi-public or a public building. By the assignment of the driving according to the intended use to the gateway, the driving of the individual sanitary articles may be carried out centrally and in coordinated fashion.

Preferably, in this variant the sanitary article controller which is configured for driving the actuator according to the intended use is deactivated.

Preferably, the driving according to the intended use and the isolated control instruction are carried out separately from one another. Preferably, the isolated control instruction is reset when an instruction according to the driving according to the intended use is carried out and is carried out after the conclusion of the instruction according to the driving according to the intended use. This means that, if the sanitary article controller is carrying out an instruction according to the driving according to the intended use, the isolated control instruction is received by the sanitary article controller, wherein the isolated control instruction cannot be carried out until after the conclusion of the action according to the driving according to the intended use. In this way, a malfunction and/or the confusion of a user by automatically triggered processes may be prevented.

Preferably, the isolated control instruction is sent to the sanitary article controller without a time delay, the sanitary article controller carrying out the control instruction immediately after reception without a time delay.

This means that an isolated control instruction is carried out straight away by the sanitary article controller. Since the isolated control instruction is carried out straight away, it does not need to be stored at the level of the sanitary article.

Preferably, the sanitary article controller furthermore has a memory which is configured to store predefined control parameters for the driving of the actuator according to the intended use and/or which is configured to store the operational data.

Particularly preferably, the control parameters remain unmodified when the isolated control instruction is received and the isolated control instruction is not storable in the memory of the sanitary article controller.

Preferably, the sanitary article has a trigger element which is operatively connected to the sanitary article controller and is configured to drive the actuator according to the intended use or to trigger a function on the sanitary article. The trigger element is, for example, an operating button or a detection sensor for detecting a user.

Preferably, the sanitary system furthermore has a computer, in particular a mobile computer. The computer has a computer communication interface and the gateway has a further communication interface. A data connection is providable between the computer communication interface and the further communication interface. Preferably, the data connection takes place via a building management system.

In one variant, the computer may be connected directly to the gateway. In another variant, the computer may be connected to the gateway via a digital network, such as the Internet or a cloud.

Preferably, the computer provides a user interface which displays the operational data stored on the gateway. The processing of the operational data is preferably carried out on the gateway. Any user input likewise takes place via the user interface, the user input being transmitted to the gateway for further processing.

Preferably, the computer is a notebook, a tablet or a smartphone. For the user input, an application which can be used by the user is stored on the computer.

Preferably, the predefined control parameters are modifiable only by an instruction which is issued by the computer.

Preferably, the control parameters are modifiable only by manual input of a user instruction on the computer.

A manual input is intended to mean an input by hand from a user. For example, by a user confirmation or active setting of a range.

Preferably, the actuator is a water valve. In particular, the actuator is a flush valve and/or a hygienic flush valve and/or check valve and/or a bypass valve. The isolated control instruction has a valve actuation instruction, in particular an opening instruction and a closing instruction and a valve opening duration.

Preferably, the sanitary system furthermore comprises at least one sensor which is connected with a further gateway communication interface via a data connection to the gateway, sensor data of the at least one sensor being transmitted to the gateway via the data connection, and the sensor data being included in the evaluation.

The sensor is, for example, a temperature sensor. Various temperatures may be recorded with the temperature sensor, for example a room temperature or a water temperature.

Preferably, the gateway has at least one further communication interface. The sanitary system furthermore has at least one third system having a third-system communication interface, a data connection being providable between the further communication interface and the third-system communication interface, via which data connection the isolated control instruction is provided to the third system by the gateway. The at least one third system may be selected from the following group:
the at least one third system is a light system having at least one lamp and wherein the isolated control instruction drives the light system, or the at least one lamp; and/or
the at least one third system is a fan system having at least one fan and wherein the isolated control instruction drives the fan system, or the at least one fan; and/or
the at least one third system is a fragrance dispenser system having at least one fragrance dispenser and wherein the isolated control instruction drives the fragrance dispenser system, or the at least one fragrance dispenser; and/or
wherein the at least one third system is an alarm system and wherein the isolated control instruction drives the alarm system.

Preferably, the operational data for the driving of the third system comprise the number of uses of the at least one sanitary article.

Further embodiments are laid down in the dependent claims.

### BRIEF DESCRIPTION OF THE DRAWINGS

Preferred embodiments of the invention are described in the following with reference to the drawings, which are only used for the purpose of explanation and are not to be considered restrictive. In the drawings,

FIG. 1 shows a schematic view of a sanitary system according to a preferred embodiment of the present invention.

### DESCRIPTION OF PREFERRED EMBODIMENTS

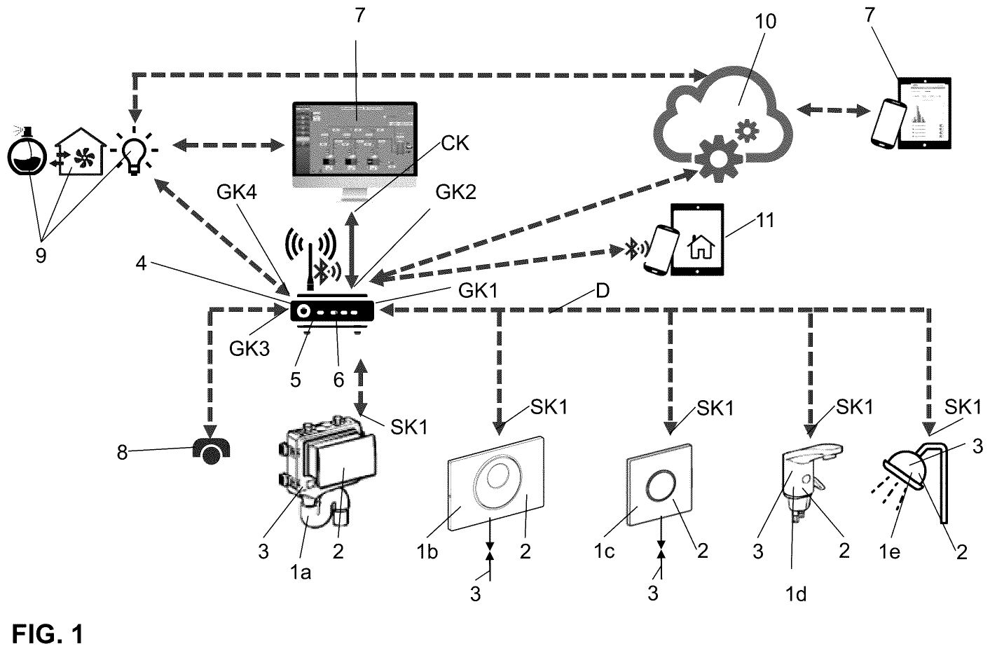

FIG. 1 shows a sanitary system according to a particularly preferred embodiment of the present invention.

The sanitary system comprises at least one sanitary article 1a, 1b, 1c, 1d, 1e and at least one gateway 4, with which the sanitary articles 1a, 1b, 1c, 1d, 1e are networked.

Each of the sanitary articles 1a, 1b, 1c, 1d, 1e respectively comprises a sanitary article controller 2 and an actuator 3. The sanitary article controller 2 is configured to drive the actuator 3 according to its intended use. The sanitary article controller 2 furthermore has a sanitary article communication interface SK1, via which the sanitary article controller 2 is networked with the gateway 4.

The at least one gateway 4 comprises a gateway communication interface GK1, a memory 5 connected to the gateway communication interface GK1, and a processor 6. The memory and the processor may also be arranged at another location, for example in the computers 7 described below. The at least one gateway 4 is connected via the gateway communication interface GK1 to the sanitary article communication interface SK1 via a data connection D. The data connection D is configured in such a way that operational data of the sanitary article controller 2 and/or of the actuator 3 are transmittable to the gateway 4 via the data connection D. Preferably, the data connection is provided by a wired or wireless connection.

The memory 5 is configured in such a way that the received operational data can be stored. The processor 6 is configured in such a way that the received operational data can be evaluated. When a predetermined evaluation criterion is reached from the evaluation of the received operational data, the processor 6 provides an isolated control instruction.

The isolated control instruction is transmittable from the gateway 4 to the sanitary article controller 2 via the data connection D. The sanitary article controller 2 then drives the actuator 3 with the isolated control instruction.

Preferably, the driving according to the intended use and the isolated control instruction are carried out separately from one another. Preferably, the isolated control instruction is reset when an instruction according to the driving according to the intended use is carried out and is carried out after the conclusion of the instruction according to the driving according to the intended use. Furthermore, it is particularly preferred for the driving according to the intended use to be deactivated at the start of carrying out the isolated control instruction. At the end of carrying out the isolated control instruction, the driving according to the intended use is reactivated.

Preferably, the isolated control instruction is sent to the sanitary article controller 2 without a time delay, that is to say in real-time or approximately in real-time, the sanitary article controller 2 carrying out the control instruction immediately after reception without a time delay, that is to say in real-time or approximately in real-time.

Preferably, the sanitary article controller 2 furthermore has a memory which is configured to store predefined control parameters for the driving of the actuator according to the intended use and/or which is configured to store the operational data.

Preferably, the control parameters remain unmodified when the isolated control instruction is received. The isolated control instruction is not storable in the memory of the sanitary article controller.

Preferably, the sanitary article has a trigger element which is operatively connected to the sanitary article controller and is configured to drive the actuator according to the intended use or to trigger a function on the sanitary article. The trigger element is, for example, a detection sensor or an operating button, or the like.

Preferably, the sanitary system furthermore has a computer 7. The computer 7 has a computer communication interface CK. The gateway has a further communication interface GK2, a data connection being providable between the computer communication interface CK and the further communication interface GK2.

The optional computer 7 is used to display information relating to the sanitary system and to input parameters for the sanitary system. The computer 7 is connected to the gateway 4 via a network structure 10 and/or a cloud structure.

There is an optional further computer 11 in the embodiment shown, which has the form of a mobile phone or a tablet or a notebook here. The further computer 11 may be connected directly to the gateway. For example, via a Bluetooth connection or another wireless or wired connection. Via this direct connection, operational data may be called up and settings may be carried out on the gateway and/or on the sanitary article controllers.

For example, the predefined control parameters are modifiable by an instruction entered on the computer 7 or on the further computer 11. In particular, the predefined control parameters are modifiable only by an instruction which is issued by the computer 7, 11. In particular, the control parameters are modifiable only by manual input of a user instruction on the computer.

FIG. 1 shows various sanitary articles, which may be used individually or in different combinations with one another in a sanitary system.

The sanitary article 1a is a hygienic flush apparatus and the actuator 3 is a valve arranged in the hygienic flush apparatus. The sanitary article controller 2 controls the valve according to a hygienic flush regime. The driving according to the intended use is preferably deactivated when the data connection has been provided. The isolated control instruction is a hygienic flush instruction, with which the valve is opened for a predetermined period of time and is closed again after the predetermined period of time has elapsed. Expressed in other words, the hygienic flush apparatus is driven with the isolated control instruction when the data connection from the gateway 4 is present.

The sanitary article 1b is a toilet (not shown in the FIGURES) having an actuation plate and the actuator 3 is a flush valve. The flush valve is driven by means of an input on the actuation plate.

The sanitary article 1c is a urinal (not shown in the FIGURES) having an actuation plate and the actuator 3 is a flush valve. The flush valve is driven by means of an input on the actuation plate.

The sanitary article 1d is an electronically driven outlet fixture in the form of a tap and the actuator 3 is a valve. The valve is driven by means of an input on the outlet fixture.

The sanitary article 1d is an electronically driven outlet fixture in the form of a shower head and the actuator 3 is a valve. The valve is driven by means of an input on the outlet fixture.

The flush valve of the toilet or of the urinal or the valve of the outlet fixture may be used according to the intended use. This means for flushing the toilet or the urinal or for a tapping process from the outlet fixture. By the incorporation into the sanitary system, however, an additional task may be also transmitted to the flush valve or the valve. For example, the flush valve or the valve may carry out a hygienic flush. This means that the flush valve or the valve is driven with the isolated control instruction for the purpose of a hygienic flush. The isolated control instruction drives the flush valve or the valve independently of the driving according to the intended use. The isolated control instruction is in this case a hygienic flush instruction, with which the valve is opened for a predetermined period of time and is closed again after the predetermined period of time has elapsed.

In the embodiment shown, the sanitary system furthermore comprises an optional sensor 8 and an optional third system 9.

The sensor 8 is connected with a further gateway communication interface GK3 via a data connection to the gateway 4. Sensor data of the at least one sensor are transmitted to the gateway via the data connection. The sensor data are included in the evaluation of the aforementioned evaluation criterion.

The gateway 4 has at least one further communication interface GK4 for the third system and the at least one third system 9 has a third-system communication interface DK. A data connection is providable between the further communication interface GK4 and the third-system communication interface DK, via which data connection the isolated control instruction is provided to the third system 9 by the gateway 4. The at least one third system 9 is driven by the isolated control instruction. The at least one third system may be configured in a variety of ways:
the at least one third system is a light system having at least one lamp and wherein the isolated control instruction drives the light system, or the at least one lamp; and/or
the at least one third system is a fan system having at least one fan and wherein the isolated control instruction drives the fan system, or the at least one fan; and/or
the at least one third system is a fragrance dispenser system having at least one fragrance dispenser and wherein the isolated control instruction drives the fragrance dispenser system, or the at least one fragrance dispenser; and/or
wherein the at least one third system is an alarm system and wherein the isolated control instruction drives the alarm system.

The alarm system may, for example, provide a message which indicates a specific number of uses and the cleaning associated therewith to the cleaning staff.

The third system 9 is furthermore connected here to the computer 7 and/or to the network structure 10 via a data connection.

### LIST OF REFERENCE SIGNS

1a, 1b, 1c, 1d, 1e sanitary article
2 sanitary article controller
3 actuator
4 gateway
5 memory
6 processor
7 computer
8 sensor
9 third system
10 network structure
11 further computer
D data connection
SK1 sanitary article communication interface
GK1 gateway communication interface
GK2 further communication interface
GK3 further communication interface
GK4 further communication interface
CK computer communication interface
DK third-system communication interface

1.-16. (canceled)

17. Sanitary system, comprising
at least one sanitary article respectively having a sanitary article controller and an actuator, wherein the sanitary article controller is configured to drive the actuator according to its intended use and wherein the sanitary article controller has a sanitary article communication interface,
at least one gateway having a gateway communication interface and
a memory which is connected to the gateway communication interface, as well as a processor,
wherein the at least one gateway is connected via the gateway communication interface to the sanitary article communication interface via a data connection, which data connection is configured in such a way that operational data of the sanitary article controller and/or of the actuator are transmittable to the gateway via the data connection,
wherein the memory is configured in such a way as to store the received operational data, and wherein the processor is configured in such a way as to evaluate the received operational data,
and wherein, when a predetermined evaluation criterion is reached from the evaluation of the received operational data, the processor provides an isolated control instruction.

18. Sanitary system according to claim 17, wherein the isolated control instruction is transmittable from the gateway to the sanitary article controller via the data connection, the sanitary article controller driving the actuator with the isolated control instruction.

19. Sanitary system according to claim 17, wherein the isolated control instruction drives the actuator independently of the driving according to the intended use, the actuator being a valve and the isolated control instruction being a hygienic flush instruction, with which the valve is opened for a predetermined period of time and is closed again after the predetermined period of time has elapsed.

20. Sanitary system according to claim 17, wherein the isolated control instruction is transmittable from the gateway to the sanitary article controller via the data connection, the sanitary article controller driving the actuator with the isolated control instruction, and wherein the isolated control instruction drives the actuator independently of the driving according to the intended use, the actuator being a valve and the isolated control instruction being a hygienic flush instruction, with which the valve is opened for a predetermined period of time and is closed again after the predetermined period of time has elapsed.

21. Sanitary system according to claim 17, wherein the sanitary article is a hygienic flush apparatus and the actuator is a valve, the driving according to the intended use being deactivated when the data connection has been provided, and the isolated control instruction being a hygienic flush instruction, with which the valve is opened for a predetermined period of time and is closed again after the predetermined period of time has elapsed.

22. Sanitary system according to claim 17, wherein the driving according to the intended use is assigned to the gateway, and wherein the isolated control instruction is a control instruction according to the intended use, such that the actuator is driven centrally by the gateway.

23. Sanitary system according to claim 17, wherein the driving according to the intended use and the isolated control instruction are carried out separately from one another, the isolated control instruction preferably being reset when an instruction according to the driving according to the intended use is carried out and being carried out after the conclusion of the instruction according to the driving according to the intended use.

24. Sanitary system according to claim 17, wherein the isolated control instruction is sent to the sanitary article controller without a time delay, the sanitary article controller carrying out the control instruction immediately after reception without a time delay.

25. Sanitary system according to claim 17, wherein the sanitary article controller furthermore has a memory which is configured to store predefined control parameters for the driving of the actuator according to the intended use and/or which is configured to store the operational data.

26. Sanitary system according to claim 17, wherein the sanitary article controller furthermore has a memory which is configured to store predefined control parameters for the driving of the actuator according to the intended use and/or which is configured to store the operational data, and wherein the control parameters remain unmodified when the isolated control instruction is received, and wherein the isolated control instruction is not storable in the memory of the sanitary article controller.

27. Sanitary system according to claim 17, wherein the sanitary article has a trigger element which is operatively connected to the sanitary article controller and is configured to drive the actuator according to the intended use or to trigger a function on the sanitary article.

28. Sanitary system according to claim 17, wherein the sanitary system furthermore has a computer, in particular a mobile computer, the computer having a computer communication interface and the gateway having a further communication interface, a data connection being providable between the computer communication interface and the further communication interface.

29. Sanitary system according to claim 17, wherein the sanitary system furthermore has a computer, in particular a mobile computer, the computer having a computer communication interface and the gateway having a further communication interface, a data connection being providable between the computer communication interface and the further communication interface, and wherein the predefined control parameters are modifiable only by an instruction which is issued by the computer,
wherein the sanitary article controller furthermore has a memory which is configured to store predefined control parameters for the driving of the actuator according to the intended use and/or which is configured to store the operational data; or
wherein the sanitary article controller furthermore has a memory which is configured to store predefined control parameters for the driving of the actuator according to the intended use and/or which is configured to store the operational data, and wherein the control parameters remain unmodified when the isolated control instruction is received, and wherein the isolated control instruction is not storable in the memory of the sanitary article controller; or
wherein the sanitary article has a trigger element which is operatively connected to the sanitary article controller and is configured to drive the actuator according to the intended use or to trigger a function on the sanitary article.

30. Sanitary system according to claim 29, wherein the control parameters are modifiable only by manual input of a user instruction on the computer.

31. Sanitary system according to claim 17, wherein the actuator is a water valve, particularly wherein the actuator is a flush valve and/or a hygienic flush valve and/or check valve and/or a bypass valve, and wherein the isolated control instruction has a valve actuation instruction, in particular an opening instruction and a closing instruction and a valve opening duration.

32. Sanitary system according to claim 17, wherein the sanitary system furthermore comprises at least one sensor which is connected with a further gateway communication interface via a data connection to the gateway, sensor data of the at least one sensor being transmitted to the gateway via the data connection, and the sensor data being included in the evaluation.

33. Sanitary system according to claim 17, wherein the gateway has at least one further communication interface and wherein the sanitary system furthermore has at least one third system having a third-system communication interface, a data connection being providable between the further communication interface and the third-system communication interface, via which data connection the isolated control instruction is provided to the third system by the gateway,
wherein the at least one third system is a light system having at least one lamp and wherein the isolated control instruction drives the light system, or the at least one lamp; and/or
wherein the at least one third system is a fan system having at least one fan and wherein the isolated control instruction drives the fan system, or the at least one fan; and/or
wherein the at least one third system is a fragrance dispenser system having at least one fragrance dispenser and wherein the isolated control instruction drives the fragrance dispenser system, or the at least one fragrance dispenser; and/or
wherein the at least one third system is an alarm system and wherein the isolated control instruction drives the alarm system.
